(19) United States
(12) Patent Application Publication
(10) Pub. No.: US 2024/0168205 A1
(43) Pub. Date: May 23, 2024

(54) REFLECTIVE ASSEMBLY

(71) Applicant: PC KRAUSE AND ASSOCIATES, INC., West Lafayette, IN (US)

(72) Inventor: Alex HELTZEL, Austin, TX (US)

(21) Appl. No.: 18/514,267

(22) Filed: Nov. 20, 2023

Related U.S. Application Data
(60) Provisional application No. 63/426,917, filed on Nov. 21, 2022.

(51) Int. Cl. G02B 5/08

(52) U.S. Cl. CPC G02B 5/0875

(57) ABSTRACT

A hybrid reflective stack assembly includes an aluminum layer, a barrier layer arranged on the aluminum layer, and a silver layer arranged on the barrier layer.

### CROSS-REFERENCE TO RELATED APPLICATIONS

This non-provisional application claims the benefit and priority, under 35 U.S.C. § 119(e) and any other applicable laws and statutes, to U.S. Provisional Application Ser. No. 63/426,917 filed on Nov. 21, 2022, the entire disclosure of which is incorporated herein by reference.

### BACKGROUND

The present disclosure relates to reflective assemblies, in particular reflective assemblies configured to reflect solar or radiant energy.

### SUMMARY

According to the present disclosure, a hybrid reflective stack assembly includes a first layer comprising an aluminum substrate, a barrier layer arranged on an upper surface of the first layer, and a second layer arranged on an upper surface of the barrier layer and comprising silver.

In some embodiments, the second layer comprising silver has thickness in a range of 10 nm to 50 nm. In some embodiments, the second layer comprising silver has thickness in a range of 15 nm to 35 nm. In some embodiments, the second layer comprising silver has thickness in a range of 26 nm to 28 nm. In some embodiments, the second layer comprising silver has thickness of about 27 nm.

In some embodiments, the barrier layer has a thickness in a range of 1 nm to 30 nm. In some embodiments, the barrier layer has a thickness in a range of 1 nm to 2 nm.

In some embodiments, the first layer comprising the aluminum substrate has a thickness of at least 100 nm.

In some embodiments, the barrier layer is comprised of one of Si, SiO₂, a nickel-chromium alloy NiCrₓ, NiCr nitride, Al₂O₃, or TiO₂. In some embodiments, the barrier layer has a thickness in a range of 1 nm to 4 nm. In some embodiments, the barrier layer has a thickness in a range of 4 nm to 10 nm.

In some embodiments, the hybrid reflective stack assembly further includes a first additional layer comprising SiO₂ or a silicon/aluminum alloy on an upper surface of the second layer comprising silver.

In some embodiments, the hybrid reflective stack assembly further includes a second additional layer comprising SiO₂ or a silicon/aluminum alloy on a bottom surface of the first layer comprising the aluminum substrate.

A hybrid reflective stack assembly according to a further aspect of the present disclosure includes an aluminum substrate, a barrier layer arranged on an upper surface of the aluminum substrate, and a silver layer arranged on an upper surface of the barrier layer. In some embodiments, the silver layer has thickness in a range of 15 nm to 35 nm, the barrier layer has a thickness in a range of 1 nm to 30 nm, and the aluminum substrate has a thickness of at least 100 nm.

In some embodiments, the silver layer has thickness in a range of 26 nm to 28 nm. In some embodiments, the silver layer has thickness of about 27 nm.

In some embodiments, the barrier layer is comprised of one of Si, SiO₂, a nickel-chromium alloy NiCrₓ, NiCr nitride, Al₂O₃, or TiO₂. In some embodiments, the barrier layer has a thickness in a range of 1 nm to 4 nm. In some embodiments, the barrier layer has a thickness in a range of 1 nm to 2 nm.

A method according to a further aspect of the present disclosure includes providing a first layer comprising an aluminum substrate, arranging a barrier layer on an upper surface of the first layer, and arranging a second layer on an upper surface of the barrier layer, the second layer comprising silver.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

FIG. 1 is a cross-sectional view of a hybrid reflective stack assembly according to the present disclosure;

FIG. 2A is a graph of wavelength versus reflectance percentage for aluminum and silver;

FIG. 2B is a graph of wavelength versus reflectance percentage for aluminum and silver, and showing a target reflectance curve;

FIG. 3 is a graph of silver layer thickness versus total solar absorption of a silver-only reflective assembly, an aluminum-only reflective assembly and the hybrid reflective stack assembly of FIG. 1 including aluminum and silver layers; and

FIG. 4 is a magnified portion of the graph of FIG. 3, showing a portion of the curve of the hybrid reflective stack assembly of FIG. 1 including aluminum and silver layers;

FIG. 5A is a graph showing measured UV-visible reflectivity as a function of wavelength for a PET substrate coated with pure silver and a PET substrate coated with the hybrid reflective stack assembly of FIG. 1 comprising a silver layer of 30 nm, an SiO2 barrier layer of 10 nm, and an aluminum layer of 150 nm, and showing normalized incident solar energy; and

FIG. 5B is a magnified view of a portion of the graph of FIG. 5A, the portion shown as a dashed line box in FIG. 5A.

### DETAILED DESCRIPTION

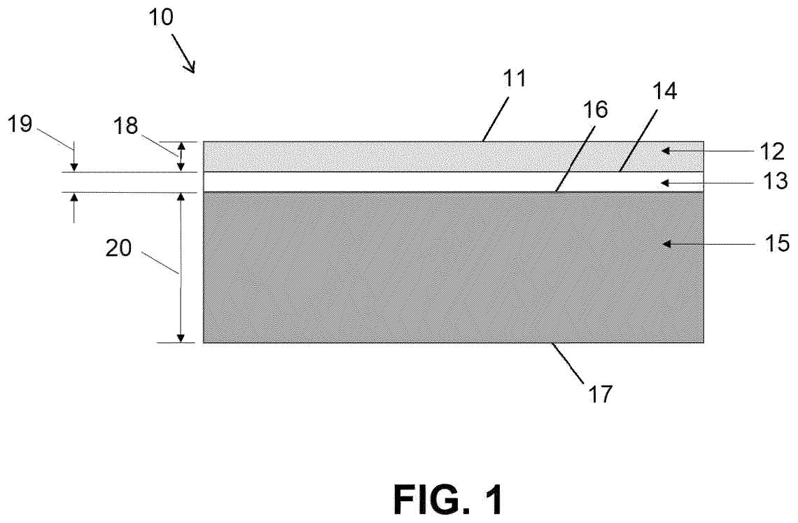

FIG. 1 illustrates a hybrid reflective stack assembly 10 according to a first aspect of the present disclosure. The disclosed composition of the hybrid reflective stack assembly 10 provides a mirror with superior overall reflectance. Illustratively, the hybrid reflective stack assembly 10 includes an ultrathin film 12 of silver (Ag) (also referred to as a “second layer 12”) arranged on an upper surface 14 of a barrier layer 13. The barrier layer 13 is arranged on an upper surface 16 of a substrate 15 of aluminum (Al) (also referred to as a “first layer”).

In some embodiments, the silver layer 12 is about 15 nm to about 35 nm in thickness 18 and any range of values therebetween. In some embodiments, the silver layer 12 is about 20 nm to about 30 nm in thickness 18 and any range of values therebetween. In some embodiments, the silver layer 12 is about 23 nm to about 27 nm in thickness 18 and any range of values therebetween. In some embodiments, the silver layer 12 is about 25 nm in thickness 18, and in some embodiments, exactly 25 nm.

In some embodiments, the barrier layer 13 is about 1 nm to about 30 nm in thickness 19 and any range of values therebetween. In some embodiments, the barrier layer 13 is about 10 nm to about 20 nm in thickness 19 and any range of values therebetween. In some embodiments, the barrier layer 13 is about 13 nm to about 17 nm in thickness 19 and any range of values therebetween. In some embodiments, the barrier layer 13 is about 15 nm in thickness 19, and in some embodiments, exactly 15 nm. In some embodiments, the barrier layer 13 is about 1 nm to about 2 nm in thickness 19 and any range of values therebetween. In some embodiments, the barrier layer 13 is about 1 nm in thickness 19, and in some embodiments, exactly 1 nm. In some embodiments, the barrier layer 13 is about 2 nm in thickness 19, and in some embodiments, exactly 2 nm.

In some embodiments, the aluminum layer 15 is at least about 100 nm in thickness 20. In some embodiments, the aluminum layer 15 is exactly 100 nm in thickness 20.

In some embodiments, the barrier layer 13 includes one of Si, SiO₂, a nickel-chromium alloy NiCrₓ, NiCr nitride (NiCrNₓ), Al₂O₃, or TiO₂. In some embodiments, additional SiO₂ or silicon/aluminum alloy barrier layers 13 (also referred to as an “additional layer”) on either side of the silver and aluminum layers 12, 15 (i.e. on an upper surface 11 of the silver layer 12 and/or on a bottom surface 17 of the aluminum layer 15) may be used to minimize oxidation of the silver and aluminum layers 12, 15. In some embodiments, a NiCrₓ barrier layer 13 has a thickness 19 in a range of 1 nm to 2 nm, which produced unexpectedly superior reflective performance to those produced by a NiCrₓ barrier layer 13 thicknesses outside of this range.

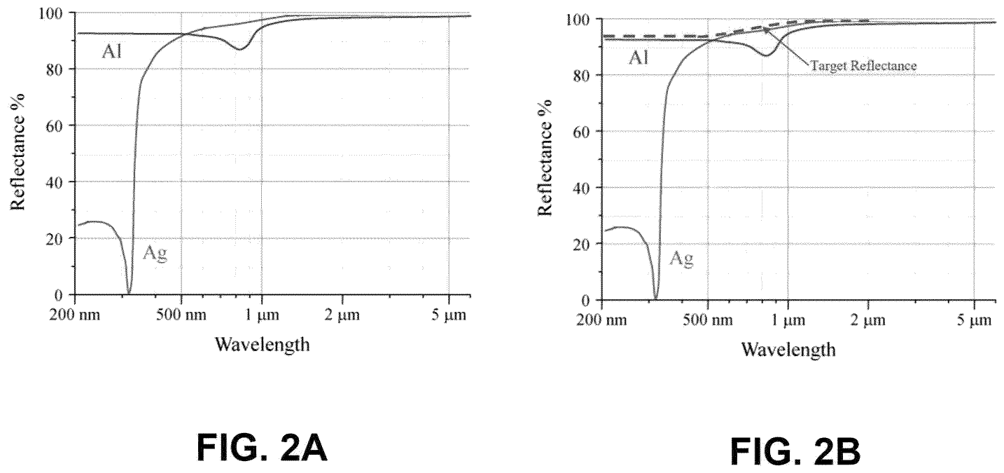

Electromagnetic modeling shows that the disclosed hybrid reflective stack assembly 10 will be able to reflect more solar energy than either silver or aluminum alone. This is due to aluminum's superior reflection in the ultraviolet range of 200-400 nm and silver's superior reflection in the visible and near-infrared range. Reflection spectra of silver and aluminum are provided in FIG. 2A, and these spectra are provided with a reference target reflectance curve in FIG. 2B.

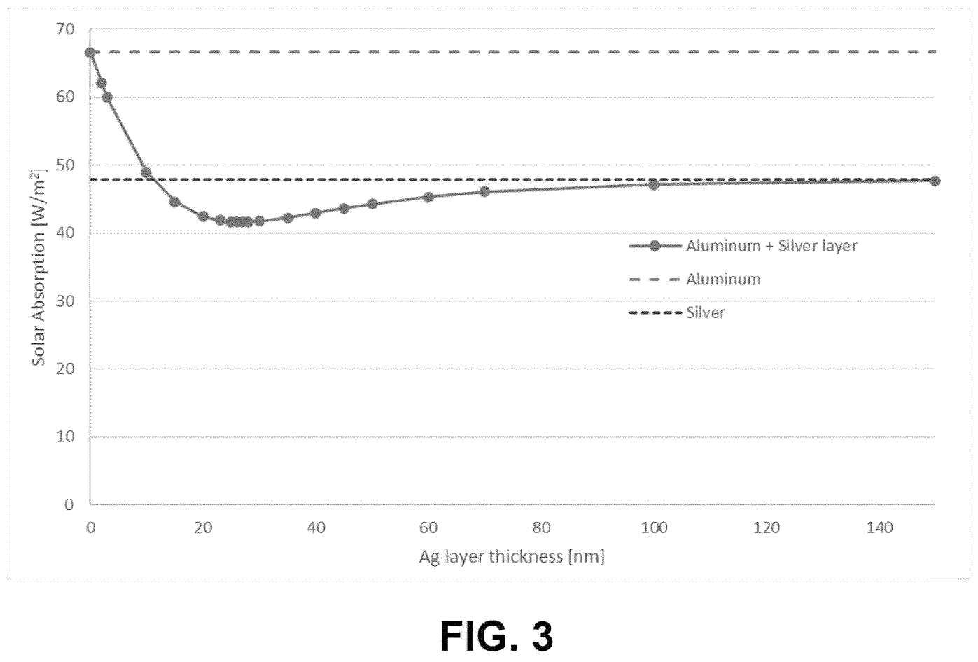

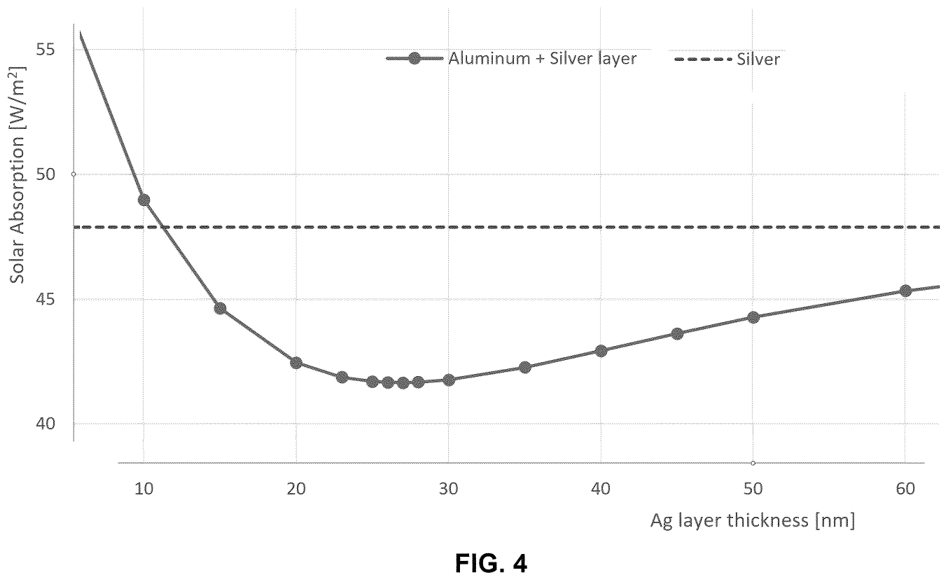

FIGS. 3 and 4 illustrate total solar absorption as a function of silver layer 12 thickness 18 of the disclosed hybrid reflective stack assembly 10, a standalone aluminum mirror, and a standalone silver mirror. Specifically, electromagnetic modeling (finite-difference time-domain solutions of Maxwell's equations) shows that, in some embodiments, a silver layer 12 thickness 18 is in a range of 15 nm to 60 nm. In some embodiments, the silver layer 12 thickness 18 is in a range of 15 nm to 35 nm, and in particular, in a range of 20 nm to 30 nm, and in particular, in a range of 26 nm to 28 nm, and in particular, about 27 nm, and in particular, exactly 27 nm. It was found that a silver layer 12 thickness 18 in the range of 26 nm to 28 nm, and in particular 27 nm, produced unexpectedly superior reflective performance to those produced by silver layer 12 thicknesses 18 outside of this range. Moreover, a silver layer 12 thickness 18 in the range of 15 nm to 60 nm still produced improved and unforeseen reflective performance as compared to those produced by silver layer thicknesses outside of this range.

When a silver layer 12 is very thin, e.g., a thickness 18 of about 0 nm, the absorption is consistent with aluminum-only, while with a silver layer 12 thickness 18 of >100 nm, the absorption is consistent with silver-only. However, surprisingly, with a silver layer 12 thickness 18 between 11 nm and approximately 100 nm, reflective properties of both the silver and the aluminum combine to create superior overall reflectance (i.e. minimized absorption), with a value of approximately 26-28 nm of the silver layer 12 thickness 18 resulting in approximately 7 W/m² reduced absorption, an improvement over comparable reflective stacks.

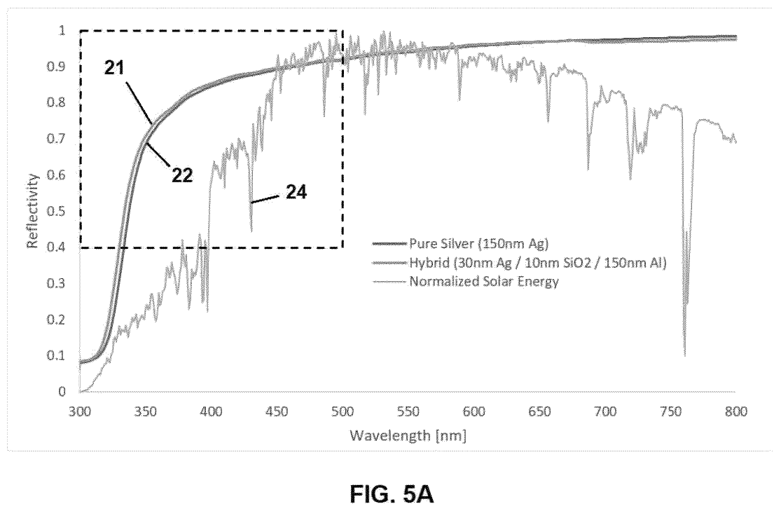

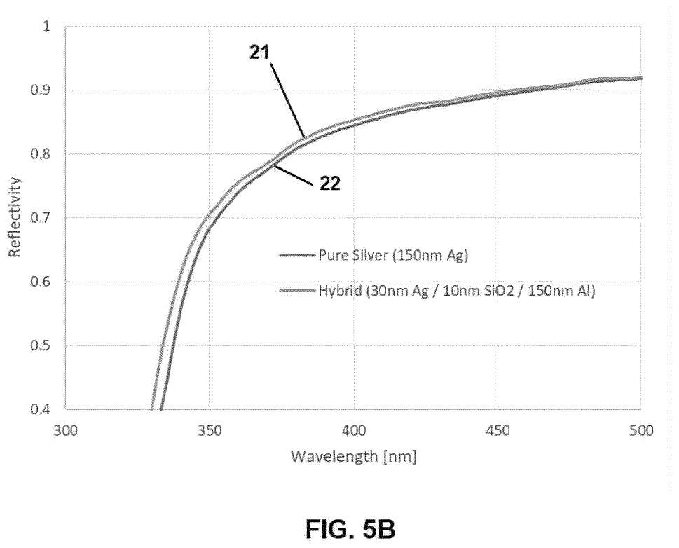

FIGS. 5A and 5B show a graph of measured reflectivity for the hybrid reflective stack assembly 10. The stack assembly 10 shown in FIGS. 5A and 5B comprises a silver layer 12 of 30 nm, an SiO2 barrier layer 13 of 10 nm, and an aluminum layer 15 of 150 nm, as well as showing normalized incident solar energy (curve 24). Thickness of over 150 nm for the silver layer 12 and 150 nm for the aluminum layer 15 is opaque and does not affect the curves. As can be seen in FIG. 5A and in more detail in FIG. 5B, the first curve 21 of the hybrid reflective stack assembly 10 exhibits higher reflectivity in the UV-visible range than a pure silver assembly, shown as the second curve 22. Integrating the reflectivity and incident solar energy provides values for total solar absorption in the UV-visible range, showing that the hybrid reflective stack assembly 10 design absorbs approximately 1.9 W/m² less energy in this range. In other words, the hybrid reflective stack assembly reflects 1.9 W/m² more energy in this range.

A method according to a further aspect of the present disclosure includes providing a first layer 15 comprising an aluminum substrate, arranging a barrier layer 13 on an upper surface 16 of the first layer 15, and arranging a second layer 12 on an upper surface 14 of the barrier layer 13, the second layer 12 comprising silver.

While the disclosure has been illustrated and described in detail in the drawings and foregoing description, such an illustration and description is to be considered as exemplary and not restrictive in character, it being understood that only illustrative embodiments have been shown and described and that all changes and modifications that come within the spirit of the disclosure are desired to be protected.

There are a plurality of advantages of the present disclosure arising from the various features of the method, apparatus, and system described herein. It will be noted that alternative embodiments of the method, apparatus, and system of the present disclosure may not include all of the features described yet still benefit from at least some of the advantages of such features. Those of ordinary skill in the art may readily devise their own implementations of the method, apparatus, and system that incorporate one or more of the features of the present invention and fall within the spirit and scope of the present disclosure as defined by the appended claims.

The features illustrated or described in connection with one exemplary embodiment may be combined with any other feature or element of any other embodiment described herein. Such modifications and variations are intended to be included within the scope of the present disclosure. Further, a person skilled in the art will recognize that terms commonly known to those skilled in the art may be used interchangeably herein.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially” is not to be limited to the precise value specified. In some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable.

The drawings, although not fully dimensioned, are to scale.

1. A hybrid reflective stack assembly, comprising
a first layer comprising an aluminum substrate,
a barrier layer arranged on an upper surface of the first layer, and
a second layer arranged on an upper surface of the barrier layer and comprising silver.

2. The hybrid reflective stack assembly of claim 1, wherein the second layer comprising silver has thickness in a range of 10 nm to 50 nm.

3. The hybrid reflective stack assembly of claim 1, wherein the second layer comprising silver has thickness in a range of 15 nm to 35 nm.

4. The hybrid reflective stack assembly of claim 1, wherein the second layer comprising silver has thickness in a range of 26 nm to 28 nm.

5. The hybrid reflective stack assembly of claim 1, wherein the second layer comprising silver has thickness of about 27 nm.

6. The hybrid reflective stack assembly of claim 2, wherein the barrier layer has a thickness in a range of 1 nm to 30 nm.

7. The hybrid reflective stack assembly of claim 6, wherein the barrier layer has a thickness in a range of 1 nm to 2 nm.

8. The hybrid reflective stack assembly of claim 6, wherein the first layer comprising the aluminum substrate has a thickness of at least 100 nm.

9. The hybrid reflective stack assembly of claim 1, wherein the barrier layer is comprised of one of Si, SiO₂, a nickel-chromium alloy NiCrₓ, NiCr nitride, Al₂O₃, or TiO₂.

10. The hybrid reflective stack assembly of claim 9, wherein the barrier layer has a thickness in a range of 1 nm to 4 nm.

11. The hybrid reflective stack assembly of claim 9, wherein the barrier layer has a thickness in a range of 4 nm to 10 nm.

12. The hybrid reflective stack assembly of claim 1, further comprising
a first additional layer comprising SiO₂ or a silicon/aluminum alloy on an upper surface of the second layer comprising silver.

13. The hybrid reflective stack assembly of claim 12, further comprising
a second additional layer comprising SiO₂ or a silicon/aluminum alloy on a bottom surface of the first layer comprising the aluminum substrate.

14. A hybrid reflective stack assembly, comprising
an aluminum substrate,
a barrier layer arranged on an upper surface of the aluminum substrate, and
a silver layer arranged on an upper surface of the barrier layer,
wherein the silver layer has thickness in a range of 15 nm to 35 nm,
wherein the barrier layer has a thickness in a range of 1 nm to 30 nm, and
wherein the aluminum substrate has a thickness of at least 100 nm.

15. The hybrid reflective stack assembly of claim 14, wherein the silver layer has thickness in a range of 26 nm to 28 nm.

16. The hybrid reflective stack assembly of claim 14, wherein the silver layer has thickness of about 27 nm.

17. The hybrid reflective stack assembly of claim 14, wherein the barrier layer is comprised of one of Si, SiO₂, a nickel-chromium alloy NiCrₓ, NiCr nitride, Al₂O₃, or TiO₂.

18. The hybrid reflective stack assembly of claim 17, wherein the barrier layer has a thickness in a range of 1 nm to 4 nm.

19. The hybrid reflective stack assembly of claim 18, wherein the barrier layer has a thickness in a range of 1 nm to 2 nm.

20. A method, comprising
providing a first layer comprising an aluminum substrate,
arranging a barrier layer on an upper surface of the first layer, and
arranging a second layer on an upper surface of the barrier layer, the second layer comprising silver.
